(19) United States
(12) Patent Application Publication
(10) Pub. No.: US 2008/0130263 A1
(43) Pub. Date: Jun. 5, 2008

(54) Thin light-guiding structure and electronic device using the same

(75) Inventors: Yu-Nan Liu, Kaohsiung (TW); Chang-Hung Pan, Taipei (TW); Jen-Min Huang, Hsinchu (TW)

Correspondence Address: BACON & THOMAS, PLLC, 625 SLATERS LANE, FOURTH FLOOR, ALEXANDRIA, VA, 22314, US

(73) Assignee: Lite-On Technology Corporation

(21) Appl. No.: 11/730,547

(22) Filed: Apr. 2, 2007

(30) Foreign Application Priority Data
Nov. 30, 2006 (TW) 95144534

(51) Int. Cl. G02B 6/00

(52) U.S. Cl. 362/26

(57) ABSTRACT

A thin light-guiding structure for guiding light to the keypad of an electronic device is provided. The thin light-guiding structure comprises a film and a plurality of light-diffusing elements. The film is located on one side of the keypad. The film has a plurality of selectable predetermined regions that the light-diffusing elements are disposed. The keypad and the light-diffusing elements are respectively disposed above and under the film, such that when the light of the light source enters the film, the light of the light source is projected to the keypad due to the light diffusion caused by the light-diffusing elements.

This application claims the benefit of Taiwan application Serial No. 95144534, filed Nov. 30, 2006, the subject matter of which is incorporated herein by reference.

### BACKGROUND OF THE INVENTION

1. Field of the Invention

The invention relates in general to a thin light-guiding structure and an electronic device using the same, and more particularly to a thin light-guiding structure capable of enhancing the illuminance of the presskey and an electronic device using the same.

2. Description of the Related Art

Under normal illumination of the lighting in the environment, users can easily press the keypad of an electronic device to input some information and make use of the functions of the electronic device. Examples of the electronic device include mobile phone, PDA and digital camera, etc. To cope with the difficulty of insufficient illumination, many electronic devices are further equipped with parts having illumination function, such that the users can use the electronic devices more conveniently at night or even in a dark environment.

Let the mobile phone be taken for example. Normally, a plurality of light emitting diodes (LEDs) or a plurality of organic light emitting diodes (OLEDs) is used as a light source for the keypad. When the LEDs are used as a light source for the keypad, the LEDs are disposed on the circuit board of the mobile phone. Normally, the LEDs are disposed under the keypad, such that the light of the LEDs is directly projected to the keypad. Since the LEDs have a certain thickness and there are also other elements (the metal dome for example) disposed between the circuit board and the keypad, the disposition of the LEDs between the circuit board and the keypad certainly increases the overall thickness of the mobile phone. Furthermore, in order to increase the luminance of each presskey of the keypad so as to meet the requirements and make the luminance of each presskey uniformed, a plurality of LEDs are installed. As a result, not only the higher manufacturing cost is demanded, the power consumption of the mobile phone is also increased. Therefore, how to provide a thin light-guiding structure with sufficient illuminance and uniformity but not using superfluous LEDs, nor involving too complicated manufacturing process or incurring more cost has become an imminent issue to be resolved.

### SUMMARY OF THE INVENTION

The invention is directed to a thin light-guiding structure and an electronic device using the same. Several light-diffusing elements are disposed on the film of the light-guiding structure. When the light of the light source of the electronic device enters the film, the light is guided to the keypad of the electronic device via the light-diffusing elements to illuminate the keypad, such that the user operates the electronic device more conveniently even in a dark environment.

According to a first aspect of the present invention, a thin light-guiding structure for guiding the light of a keypad is provided. The thin light-guiding structure comprises a film and a plurality of light-diffusing elements. The film is located on one side of the keypad. The light-diffusing elements are disposed on the film. The film has a plurality of selectable predetermined regions disposed in which the light-diffusing elements are disposed. The keypad and the light-diffusing elements are respectively disposed above and under the film, such that when the light of the light source enters the film, the light of the light source is projected to the keypad due to the light diffusion caused by the light-diffusing elements.

According to a second aspect of the present invention, an electronic device including a light-guiding structure, a keypad, a circuit board and at least a light source unit is provided. The light-guiding structure includes a film and a plurality of light-diffusing elements. The light-diffusing elements are disposed within a plurality of selectable predetermined regions located on the film. The keypad is disposed above the light-guiding structure. The keypad and the light-diffusing elements are respectively disposed above and under the film. The circuit board is disposed under the light-guiding structure. The light-diffusing elements are disposed between the circuit board and the film. When the light of the light source unit enters the film, the light source is projected to the keypad due to the light diffusion caused by light-diffusing elements.

The invention will become apparent from the following detailed description of the preferred but non-limiting embodiments. The following description is made with reference to the accompanying drawings.

### BRIEF DESCRIPTION OF THE DRAWINGS

FIG. 1 is an exploded diagram of an electronic device according to a preferred embodiment of the invention;

FIG. 2 is a partial enlargement of a light-guiding structure of FIG. 1;

FIG. 3 is a partial sectional view of the electronic device of FIG. 1 after assembly;

FIG. 4 is a partial sectional view of the electronic device FIG. 3 with two light source units; and

FIG. 5 is a partial sectional view of an electronic device according to another preferred embodiment of the invention after assembly.

### DETAILED DESCRIPTION OF THE INVENTION

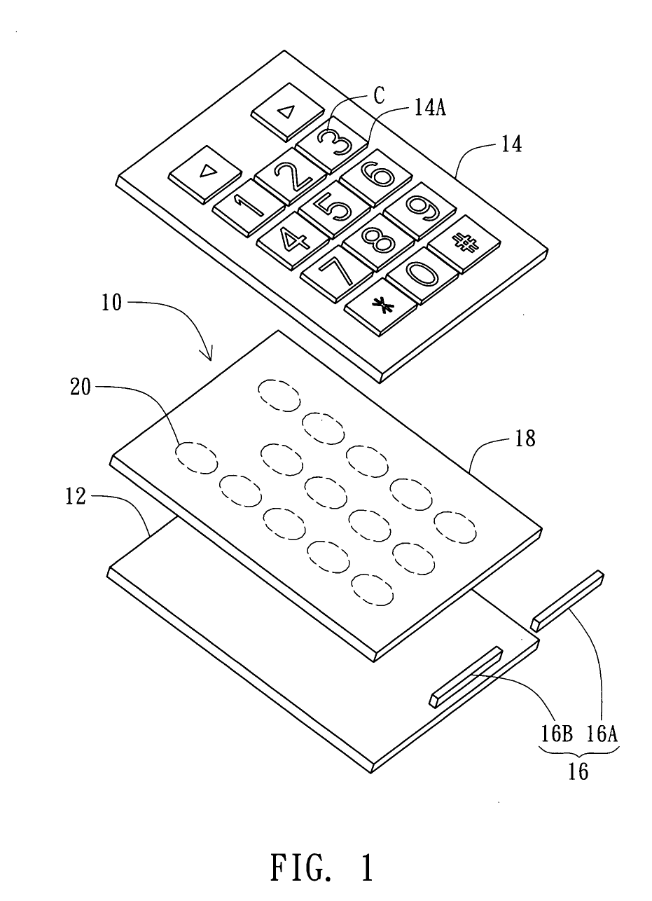

Referring to FIG. 1, an exploded diagram of an electronic device according to a preferred embodiment of the invention is shown. As shown in FIG. 1, the electronic device 1 includes a light-guiding structure 10, a circuit board 12, a keypad 14 and a light source unit 16. The circuit board 12 is disposed under the light-guiding structure 10. The keypad 14 is disposed above the light-guiding structure 10. The light source unit 16 is located on one side of the light-guiding structure 10. The light-guiding structure 10 comprises a film 18 and a plurality of light-diffusing elements 20. The light-diffusing elements 20 are disposed within a plurality of selectable predetermined regions located on the film 18. In FIG. 1, the light-diffusing elements 20 are disposed on the under surface of the film 18, and the keypad 14 and the light-diffusing elements 20 are respectively disposed above and under the film 18. When the light of the light source unit 16 enters the film 18, the light is projected to the keypad 14 due to the light diffusion caused by the light-diffusing elements 20.

The light-guiding structure 10 is actually a thin light-guiding structure whose film 18 is made of plastics or other materials. If the film 18 is a plastic film, the film is made of thermosetting or thermoplastic material such as polyethylene terephthalate (PET), polyethylene (PE) or polycarbonate (PC). The light source unit 16 comprising at least one light-emitting diode is preferably located on one lateral side of the film 18. In the present embodiment of the invention, the light source unit 16 comprises two light-emitting diodes 16A and 16B. The thickness of the light-emitting diodes 16A and 16B is approximately equal to 0.4 millimeter (mm), and the thickness of the film 18 is approximately equal to 0.125 mm. Preferably, the film 18 is disposed within the illuminating area of the light-emitting diodes 16A and 16B. As shown in FIG. 1, the keypad 14 comprises a plurality of presskeys 14A. The predetermined regions located on the light-guiding structure 10 are selected according to the positions of the presskeys 14A, and light-diffusing elements 20 can be designed to be located on the film 18 by using optical layout software, such that the positions of the light-diffusing elements 20 are preferably corresponding to the positions of the presskeys 14A. Practically, the light-diffusing elements 20 can be disposed on the film 18 according to the positions of the presskeys 14A or according to actual requirements such that the light-diffusing elements 20 form a pattern on the film 18. In the present embodiment of the invention, one presskey 14A corresponds to one light-diffusing element 20. However, in practical application, the pattern that the light-diffusing elements 20 formed on the film 18 can be determined according to the design that one presskey 14A corresponds to a plurality of light-diffusing elements 20 or the design that a plurality of presskeys 14A correspond to one light-diffusing element 20.

Each presskey 14A of the keypad 14 has its corresponding letter, number and symbol, but in FIG. 1 only illustrates the keys with number and symbol. For users to use the electronic device more conveniently in a dark environment, the letters, numbers and symbols on the presskey 14A are normally transparent or semi-transparent, such that the light can pass through the presskey to facilitate the users. In the present embodiment of the invention, part of the presskey are hollowed as a hollowed portion C to form the number or the symbol on each presskey 14A, and the hollowed portion C can be further filled with transparent or semi-transparent material.

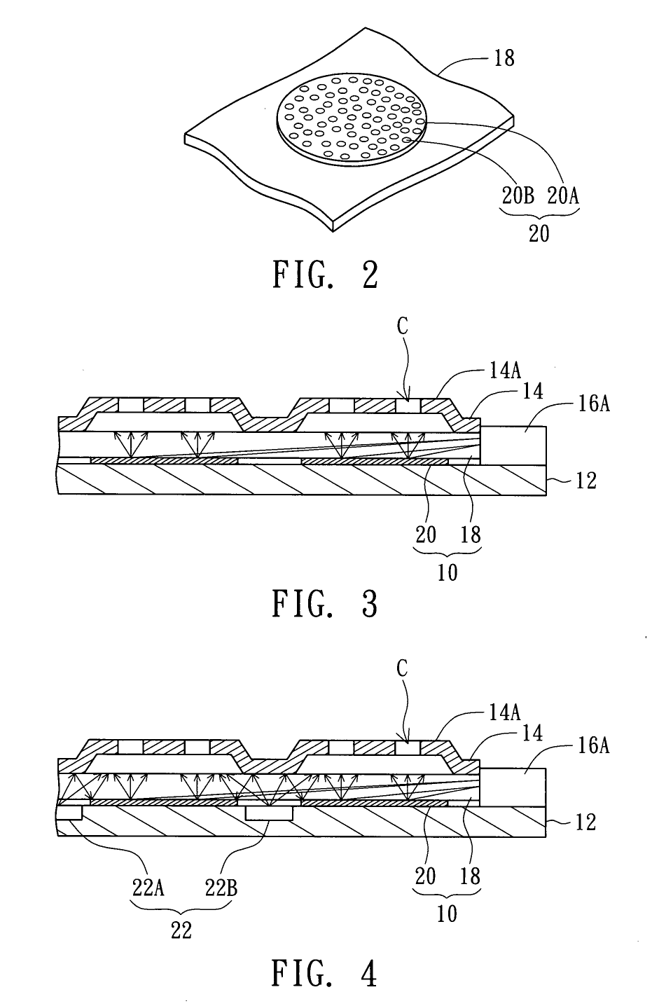

Referring to FIG. 2, a partial enlargement of a light-guiding structure of FIG. 1 is shown. As shown in FIG. 2, the light-diffusing element 20 on the film 18 comprises an adhesive 20A and a plurality of diffusion particles 20B. Preferably, the diffusion particles 20B are evenly spread over the adhesive 20A. The diffusion particles 20B are made of silicon dioxide (SiO₂), titanium dioxide (TiO₂), or a combination thereof. Preferably, the dimension of each diffusion particle 20B is approximately 0.3 millimeter. The light-diffusing elements 20 can be formed on the film 18 by means of several manufacturing processes. For example, after the material of the light-diffusing elements 20 is disposed in a predetermined position on the film 18 by screen printing or sputtering, a curing process is further performed to form the light-diffusing elements 20. In the present embodiment of the invention, the light-diffusing elements 20 are formed on the film 18 according to the above manufacturing process. However the technology of the invention is not limited thereto.

Referring to FIG. 3, a partial sectional view of the electronic device of FIG. 1 after assembly is shown. As shown in FIG. 3, during the assembly of the electronic device 1, the film 18 of the light-guiding structure 10 is disposed on the circuit board 12, such that one side of the light-diffusing elements 20 directly contacts the circuit board 12, and the keypad 14 is disposed on the film 18 afterwards. The keypad 14 and the light-diffusing elements 20 are respectively disposed above and under the film 18. The light-diffusing elements 20 are disposed in accordance with the presskeys 14A. The light-emitting diode 16A of the light source unit 16 is located on one side of the film 18, and the light of the light source enters the film 18 from a lateral side of the film 18. When the light-emitting diode 16A is driven to illuminate, the light will enter the film 18 from different incident angles, and part of the light are projected onto the light-diffusing elements 20 of the film 18. Let the light-diffusing elements 20 of FIG. 3 be taken for example. Since each light-diffusing elements 20 has many diffusion particles 20B (referring to FIG. 2), after the lightprojects to the diffusion particles 20B, the light is then reflected from different angles. In other words, the light diffusion phenomenon occurs. Thus, the distribution of the illuminance of the presskeys corresponding to the light-diffusing elements 20 becomes more uniformed, such that the transparency effect of the hollowed portion C is better. Therefore, even when the electronic device is used in a dark environment, users still can press the presskeys correctly.

The light-guiding structure 10 is a thin light-guiding structure. Normally, a metal dome (not illustrated) is disposed between the light-guiding structure 10 and the circuit board 12, such that when the presskey 14A is pressed, the circuit board 12 is triggered and outputs an electric signal. Because the film 18 of the light-guiding structure 10 enlarges the gap between the presskey 14A and the circuit board 12, the film 18 stabilizes the metal dome when the presskey 14A is pressed, such that the neighboring presskeys are less likely to be pressed, and the presskey 14A is less likely to be erroneously activated.

Besides, the electronic device 1 can further comprise a plurality of light source units. Referring to FIG. 4, a partial sectional view of the electronic device FIG. 3 with two light source units is shown. As shown in FIG. 4, the electronic device 1 comprises another light source unit 22 located on the circuit board 12 and under the film 18. The light source unit 22 comprises at least one light-emitting diode. In the present embodiment of the invention, the light source unit 22 is exemplified by having two light-emitting diodes 22A and 22B. The circuit board 12 is a printed circuit board. Several holes are designed on the substrate to accommodate the light-emitting diodes 22A and 22B. The holes and the light-diffusing elements 20 are preferably non-overlapping or partially overlapping with each other. Therefore, when the light-emitting diodes 22A and 22B illuminate, the light is projected between the circuit board 12 and the keypad 14. The light of the light-emitting diode 22A and 22B can be directly projected to the keypad 14, or diffused to the presskey 14A via the light-diffusing elements 20 on the film 18. In the present embodiment of the invention, the light-emitting diodes 22A and 22B are disposed within the holes of the substrate, so the thickness of the electronic device can be reduced.

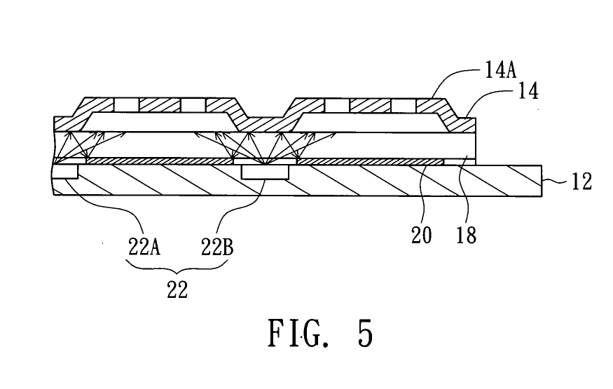

In practical application, the electronic device 1 can possibly comprise only one single light source unit, such as the light source unit 22, located in the hole on the substrate of the circuit board 12. Referring to FIG. 5, a partial sectional view of an electronic device according to another preferred embodiment of the invention after assembly is shown. As for the same elements in the previous embodiment, the same numeric designations are used. It is noted that the numeric designations of the same elements of FIG. 4 are used in FIG. 5. As shown in FIG. 5, the electronic device 1 comprises only one light source unit 22 disposed in the circuit board 12 and under the film 18. The light source unit 22 comprises two light-emitting diodes 22A and 22B. Several holes are disposed on the substrate of the circuit board 12 for accommodating the light-emitting diodes 22A and 22B. The holes and the light-diffusing elements 20 are preferably non-overlapping or partially overlapping with each other. Therefore, when the light-emitting diodes 22A and 22B illuminate, the light is evenly spread between the circuit board 12 and the keypad 14. The light of the light-emitting diode 22A and 22B can be directly projected to the keypad 14, or diffused to the presskey 14A via the light-diffusing elements 20 on the film 18. In the present embodiment of the invention, the light-emitting diodes 22A and 22B are disposed within the holes of the plastic substrate, so the thickness of the electronic device can be reduced.

Compared with the conventional practice of disposing a plurality of light-emitting diodes under the keypad of an electronic device hence increasing the thickness of the electronic device, the light-guiding structure 10 of the present embodiment of the invention is much thinner and lighter and is applicable to most thin electronic devices. Furthermore, the pattern of the light-diffusing elements 20 of the light-guiding structure 10 can be designed to meet actual requirements. The plastic material, the adhesive and the diffusion particles also have the advantage of high availability, and the manufacturing process of the light-guiding structure 10 is simple.

According to the thin light-guiding structure and the electronic device using the same disclosed in the above embodiment of the invention, a light-guiding structure with light-diffusing elements is disposed between the keypad and the circuit board of an electronic device. The light of the electronic device is emitted from a lateral or under side of the light-guiding structure, and the light is diffused to the presskeys via the light-diffusing elements. Therefore, the presskeys have uniformed illuminance, and the users can press the keypad correctly when using electronic device in a dark environment. Since the light is effectively and uniformly diffused, there is no need to install superfluous light-emitting diodes.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A thin light-guiding structure for guiding the light of a keypad, the light-guiding structure comprises:
a film located on one side of the keypad, the film has a plurality of selectable predetermined regions; and
a plurality of light-diffusing elements disposed within the predetermined regions located on the film and, wherein the keypad and the light-diffusing elements are respectively disposed above and under the film, such that when the light of at least one light source enters the film, the light of the light source is projected to the keypad due to the light diffusion caused by the light-diffusing elements.

2. The light-guiding structure according to claim 1, wherein the keypad has a plurality of presskeys, and the predetermined regions are located on the film in accordance with the presskeys.

3. The light-guiding structure according to claim 1, wherein the light-diffusing elements form a pattern on the film.

4. The light-guiding structure according to claim 1, wherein the light-diffusing elements each comprises a plurality of diffusion particles.

5. The light-guiding structure according to claim 4, wherein the diffusion particles are made of silicon dioxide, titanium dioxide, or a combination thereof.

6. The light-guiding structure according to claim 4, wherein the light-diffusing elements further comprises an adhesive in which the diffusion particles are located.

7. The light-guiding structure according to claim 1, wherein the light source is located on a lateral side of the film.

8. The light-guiding structure according to claim 1, wherein the light source is disposed under the film.

9. An electronic device, comprising:
a light-guiding structure comprising a film and a plurality of light-diffusing elements, wherein the light-diffusing elements are disposed within a plurality of selectable predetermined regions located on the film;
a circuit board disposed under the light-guiding structure;
a keypad disposed above the light-guiding structure, wherein the keypad and the light-diffusing elements are respectively disposed above and under the film; and
at least one light source unit located on one side of the light-guiding structure;
wherein, when the light of the light source unit enters the film, the light is projected to the keypad due to the light diffusion caused by the light-diffusing elements.

10. The electronic device according to claim 9, wherein the keypad has a plurality of presskeys, and the predetermined regions are located on the film in accordance with the presskeys.

11. The electronic device according to claim 9, wherein the light source unit is located on a lateral side of the film.

12. The electronic device according to claim 11, wherein the light source unit comprises at least one light-emitting diode disposed on the lateral side of the film.

13. The electronic device according to claim 9, wherein the light source unit is disposed in a substrate of the circuit board.

14. The electronic device according to claim 13, wherein the light source unit comprises at least one light-emitting diode disposed in the substrate of the circuit board.

15. The electronic device according to claim 14, wherein the substrate has at least one hole, and the light-emitting diode is disposed within the hole, and the light-diffusing elements and the hole are non-overlapping or partially overlapping.

16. The electronic device according to claim 9, wherein the light-diffusing elements form a pattern on the film.

17. The electronic device according to claim 9, wherein the light-diffusing elements each comprises a plurality of diffusion particles.

18. The electronic device according to claim 17, wherein the diffusion particles are made of silicon dioxide, titanium dioxide, or a combination thereof.

19. The electronic device according to claim 17, wherein the light-diffusing elements further comprise an adhesive in which the diffusion particles are located.
